(19) United States
(12) Patent Application Publication
(10) Pub. No.: US 2025/0021576 A1
(43) Pub. Date: Jan. 16, 2025

(54) SYSTEMS AND METHODS FOR MANAGING SEQUENTIAL, HIERARCHICAL DATA SETS

(71) Applicant: IO3O LLC, Oklahoma City, OK (US)

(72) Inventors: John Kerber, Oklahoma City, OK (US); Luke Buikema, Oklahoma City, OK (US)

(21) Appl. No.: 18/747,888

(22) Filed: Jun. 19, 2024

Related U.S. Application Data
(60) Provisional application No. 63/509,144, filed on Jun. 20, 2023.

(51) Int. Cl. G06F 16/25; G06F 16/28

(52) U.S. Cl. CPC G06F 16/258; G06F 16/282

(57) ABSTRACT

A system and method are herein disclosed. The system comprises a processor and a memory. The memory comprises a non-transitory processor-readable medium storing processor-executable instructions that when executed by the processor, causes the processor to: receive a report data structure having plurality of parent questions; receive a plurality of child questions directed to at least one aspect of the plurality of parent questions; associate at least one transformation function with at least one child question of the plurality of child questions, the at least one transformation function having an output as a response to at least one of the plurality of parent questions; and generate a report based on the output of the at least one transformation function and having the report data structure.

### CROSS-REFERENCE TO RELATED APPLICATIONS

The present application is a non-provisional utility application claiming priority to U.S. Provisional Application 63/509,144, titled “Systems and Methods for Managing Sequential, Hierarchical Data Sets” filed on Jun. 20, 2023, the entire content of which is hereby expressly incorporated herein by reference in its entirety.

### BACKGROUND

Public libraries in the United States are tasked with keeping track of different statistics throughout the year. Some categories of statistics are used to report to local governing boards about how the library is being used. Other categories of the statistics are utilized for general managerial and operational purposes. However, libraries are also tasked by the State Library for statistical responses which must be reported at the end of each year.

Although the information being captured for both State and Local categories is similar, there are important differences between each category. These differences make tracking and calculation of annual State category statistics complex and challenging.

Furthermore, because the information being captured is different, library administrators are required to generate reports for different agencies at different governmental levels utilizing similar information, thereby increasing the chance of miscalculations or other data entry errors which may take a significant amount of time and resources to correct.

### SUMMARY

Therefore, a need exists for systems and methods to allow entry of data at either a daily or monthly rate at a local level to be efficiently managed to provide reports for each category of statistics without requiring duplicate entry of required information or statistics.

The problem of efficient management of the entry of data at either a daily or monthly rate at a local level to provide reports for multiple categories of reports without requiring duplicate entry of required information or statistics is solved by the systems and methods herein disclosed. The systems and methods include a system comprising a processor and a memory. The memory comprises a non-transitory processor-readable medium storing processor-executable instructions that when executed by the processor, causes the processor to: receive a report data structure having plurality of parent questions; receive a plurality of child questions directed to at least one aspect of the plurality of parent questions; associate at least one transformation function with at least one child question of the plurality of child questions, the at least one transformation function having an output as a response to at least one of the plurality of parent questions; and generate a report based on the output of the at least one transformation function and having the report data structure.

Implementations of the above techniques include methods, apparatus, systems, and computer program products. One such computer program product is suitably embodied in a non-transitory computer-readable medium that stores instructions executable by one or more processors. The instructions are configured to cause the one or more processors to perform the above-described actions.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure.

FIG. 2 is a diagram of an exemplary embodiment of a user device for use in the system of FIG. 1 constructed in accordance with the present disclosure.

FIG. 3 is a diagram of an exemplary embodiment of a coordination system of the system of FIG. 1 constructed in accordance with the present disclosure.

FIG. 4 is a process flow diagram of an exemplary embodiment of a process in accordance with the present disclosure.

FIGS. 5A-F are screenshots of exemplary embodiments of the primary user interface of FIG. 1 constructed in accordance with the present disclosure.

FIG. 6 is a diagram of an exemplary embodiment of a hierarchy tree constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable media may include a non-volatile memory, a random access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, combinations thereof, and/or the like.

Such non-transitory computer-readable media may be electrically based, optically based, magnetically based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

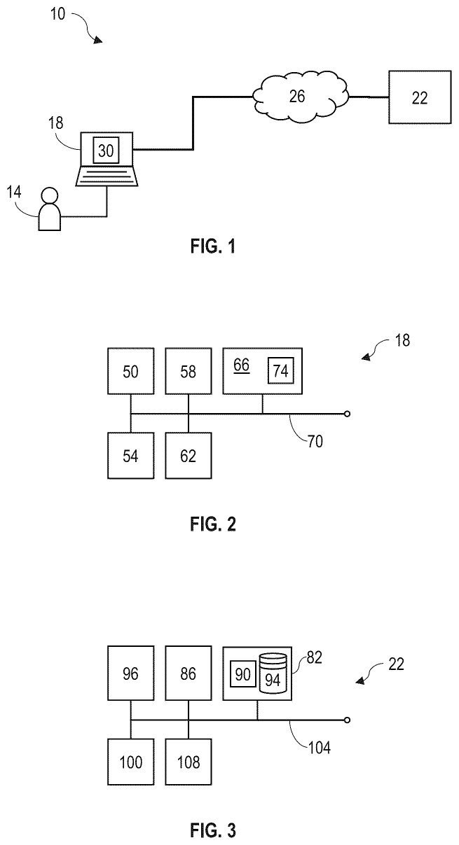

Referring now to the drawings, and in particular to FIG. 1, shown therein is a diagram of an exemplary embodiment of a system 10 constructed in accordance with the present disclosure. A user 14 may interact with the system 10 using a user device 18 that may be used to access a coordination system 22. The user device 18 may communicate with the coordination system 22 via a network 26.

In one embodiment, the user 14 is a branch user, a branch administrator, a library system user, and/or a library system administrator. A branch user or branch administrator may be a user associated with a public library branch location, e.g., member location or building of a library system. A library system user or a library system administrator may be a user associated with the public library system comprising one or more public library branch location.

In some embodiments, the network 26 may be the Internet and/or other network. For example, if the network 26 is the Internet, a primary user interface 30 (described below in more detail) of the system 10 may be delivered through a series of web pages or private internal web pages of a company or corporation, which may be written in hypertext markup language (HTML/PHP/JavaScript), for example, and may be accessible by the user device 18. It should be noted that the primary user interface 30 of the system 10 may be another type of interface including, but not limited to, a Windows-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRaWAN, a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination thereof.

Referring now to FIG. 2, shown therein is a diagram of an exemplary embodiment of the user device 18 of the system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 18 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 26, one or more memory 66 (hereinafter “memory 66”) storing processor-executable code and/or software application(s) 74 (hereinafter “user application 74”). The user application 74 may include, for example, a web browser capable of accessing a website and/or communicating information and/or data over a wireless or wired network (e.g., the network 26), and/or the like. The input device 50, output device 54, processor 58, communication device 62, and memory 66 may be connected via a path 70 such as a data bus that permits communication among the components of user device 18.

The memory 66 may be one or more non-transitory processor-readable medium. The memory 66 may store the user application 74 that, when executed by the processor 58, causes the user device 18 to perform an action such as communicate with or control one or more component of the user device 18 and/or, via the network 26, the coordination system 22. The memory 66 may be one or more memory 66 working together, or independently, to store processor-executable code and may be located locally or remotely, e.g., accessible via the network 26.

The input device 50 may be capable of receiving information input from the user 14 (e.g., as a user input) and/or processor 58, and transmitting such information to other components of the user device 18 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The output device 54 may be capable of outputting information in a form perceivable by the user 14 and/or processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example. The output device 54 may display the primary user interface 30 on the user device 18.

The network 26 may permit bi-directional communication of information and/or data between the user device 18 and/or the coordination system 22. The network 26 may interface with the coordination system 22 and/or the user device 18 in a variety of ways. For example, in some embodiments, the network 26 may interface by optical and/or electronic interfaces, and/or may use a plurality of network topographies and/or protocols including, but not limited to, Ethernet, TCP/IP, circuit switched path, combinations thereof, and/or the like, as described above.

Exemplary embodiments of the processor 58 may include, but are not limited to, a digital signal processor (DSP), a central processing unit (CPU), a field programmable gate array (FPGA), a microprocessor, a multi-core processor, an application specific integrated circuit (ASIC), combinations thereof, and/or the like, for example. The processor 58 may be capable of communicating with the memory 66 via the path 70 (e.g., data bus). The processor 58 may be capable of communicating with the input device 50 and/or the output device 54. The processor 58 may include one or more processor 58 working together, or independently, and located locally, or remotely, e.g., accessible via the network 26.

Referring now to FIG. 3, shown therein is a diagram of an exemplary embodiment of the coordination system 22 constructed in accordance with the present disclosure. The coordination system 22 may include one or more device that execute(s) one or more application or service in a manner described herein. In the illustrated embodiment, the coordination system 22 is provided with a memory 82 (hereinafter “memory 82”) accessible by one or more processor 86 (hereinafter “processor 86”). The memory 82 may include one or more non-transitory computer-readable medium storing processor-executable code and/or software application(s) 90 (hereinafter “coordination application 90”) and one or more database 94 (hereinafter “database 94”).

In one embodiment, the database 94 can be a relational database or a non-relational database. Examples of such databases comprise, DB2®, Microsoft® Access, Microsoft® SQL Server, Oracle®, MySQL, PostgreSQL, MongoDB, Apache Cassandra, and the like. It should be understood that these examples have been provided for the purposes of illustration only and should not be construed as limiting the presently disclosed inventive concepts. The database 94 can be centralized or distributed across multiple systems.

In some embodiments, the coordination system 22 may comprise the one or more processor 86 working together, or independently to, execute processor-executable code, such as the coordination application 90, stored on the memory 82. Additionally, the coordination system 22 may include at least one input device 96 (hereinafter “input device 96”) and at least one output device 100 (hereinafter “output device 100”). Each element of the coordination system 22 may be partially or completely network-based or cloud-based, and may or may not be located in a single physical location.

The processor 86 may be implemented as a single processor or multiple processors working together, or independently, to execute the coordination application 90 as described herein. It is to be understood, that in certain embodiments using more than one processor 86, the processors 86 may be located remotely from one another, located in the same location, or comprising a unitary multi-core processor. The processors 86 may be capable of reading and/or executing processor-executable code and/or capable of creating, manipulating, retrieving, altering, and/or storing data structures into the memory 82 such as in the database 94.

Exemplary embodiments of the processor 86 may be constructed similar to and in accordance with the processor 58 described above in more detail. The processor 86 may be capable of communicating with the memory 82 via a path 104 (e.g., data bus). The processor 86 may be capable of communicating with the input device 96 and/or the output device 100.

The processor 86 may be further capable of interfacing and/or communicating with the user device 18 via the network 26 using a communication device 108. For example, the processor 86 may be capable of communicating via the network 26 by exchanging signals (e.g., analog, digital, optical, and/or the like) via one or more port (e.g., physical or virtual ports) using a network protocol to provide updated information to the user application 74 or the primary user interface 30 executed on the user device 18.

In some embodiments, the memory 82 may be located in the same physical location as the coordination system 22, and/or one or more memory 82 may be located remotely from the coordination system 22. For example, the memory 82 may be located remotely from the coordination system 22 and communicate with the processor 86 via the network 26. Additionally, when more than one memory 82 is used, a first memory 82 may be located in the same physical location as the processor 86, and additional memory 82 may be located in a location physically remote from the processor 86. Additionally, the memory 82 may be implemented as a “cloud” non-transitory processor-readable medium (i.e., one or more memory 82 may be partially or completely based on or accessed using the network 26).

The memory 82 may store processor-executable code and/or information comprising the database 94 and the coordination application 90. In some embodiments, the coordination application 90 may be stored as a compiled application file, such as an executable file, for example, or in a structure (or unstructured) format, such as, e.g., in a non-compiled file.

The input device 96 of the coordination system 22 may transmit data to the processor 86 and may be constructed in accordance with or similar to the input device 50 of the user device 18 described above in more detail. The input device 96 may be located in the same physical location as the processor 86, or located remotely and/or partially or completely network-based. The output device 100 of the coordination system 22 may transmit information from the processor 86 to the user 14, and may be similar to the output device 54 of the user device 18. The output device 100 may be located with the processor 86, or located remotely and/or partially or completely network-based.

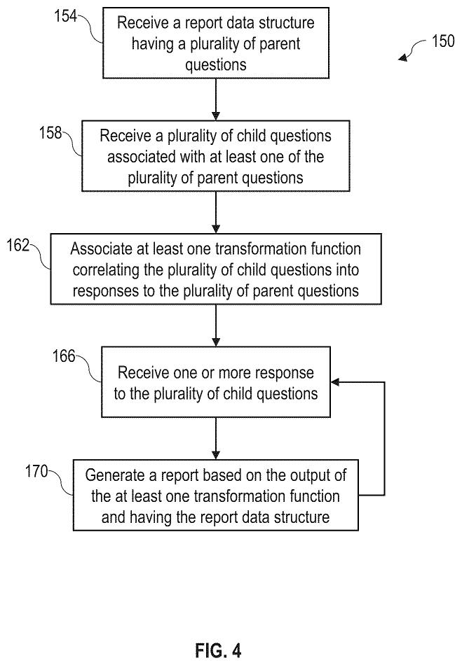

Referring now to FIG. 4, shown therein is a process flow diagram of an exemplary embodiment of a process 150 constructed in accordance with the present disclosure. The process 150 generally comprises the steps of: receiving a report data structure having plurality of parent questions (step 154); receiving a plurality of child questions associated with at least one of the plurality of parent questions (step 158); associating at least one transformation function correlating the plurality of child questions into responses to at least one of the plurality of parent questions (step 162); receiving one or more response to the plurality of child questions (step 166); and generating a report based on the output of the at least one transformation function and having the report data structure (step 170). In one embodiment, the process 150 may be programmed (e.g., as the coordination application 90) as a series of steps to be performed by the processor 86.

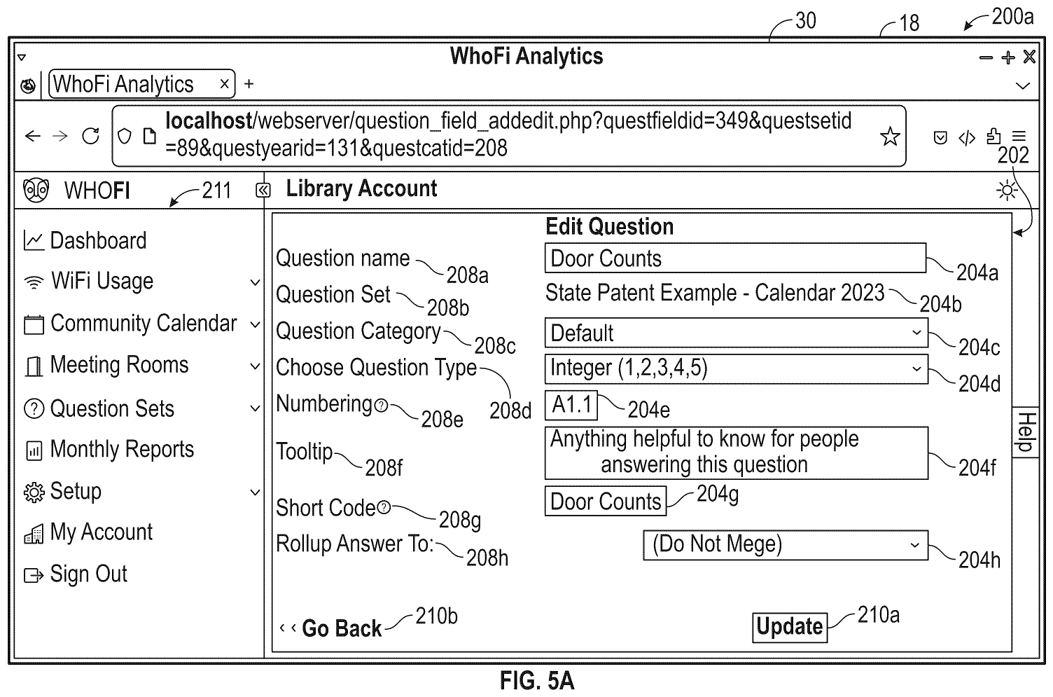

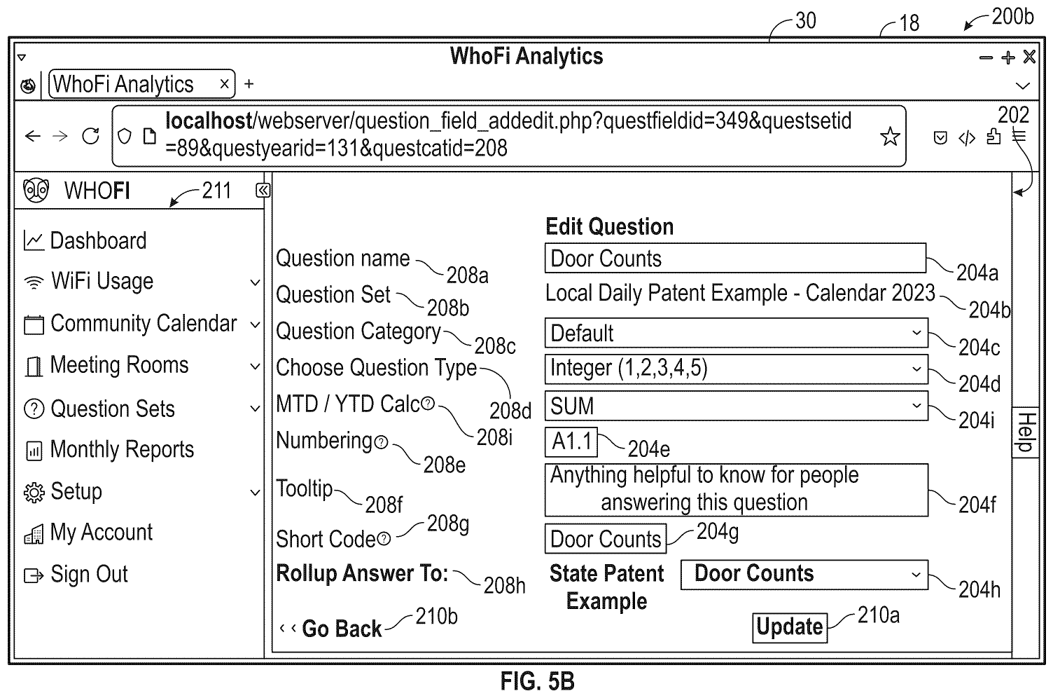

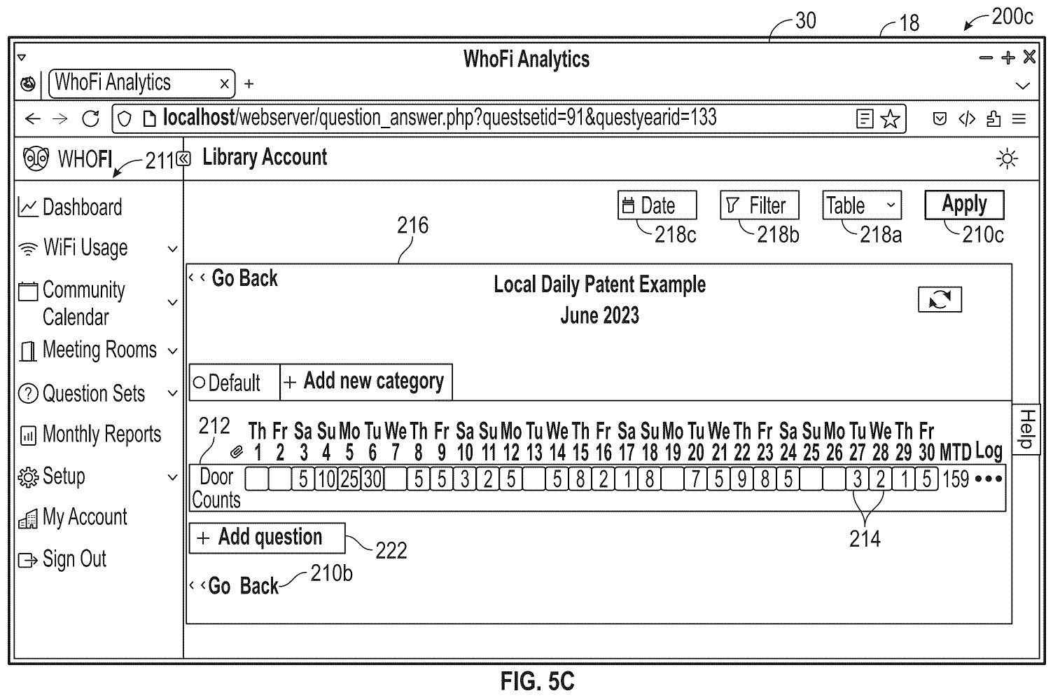

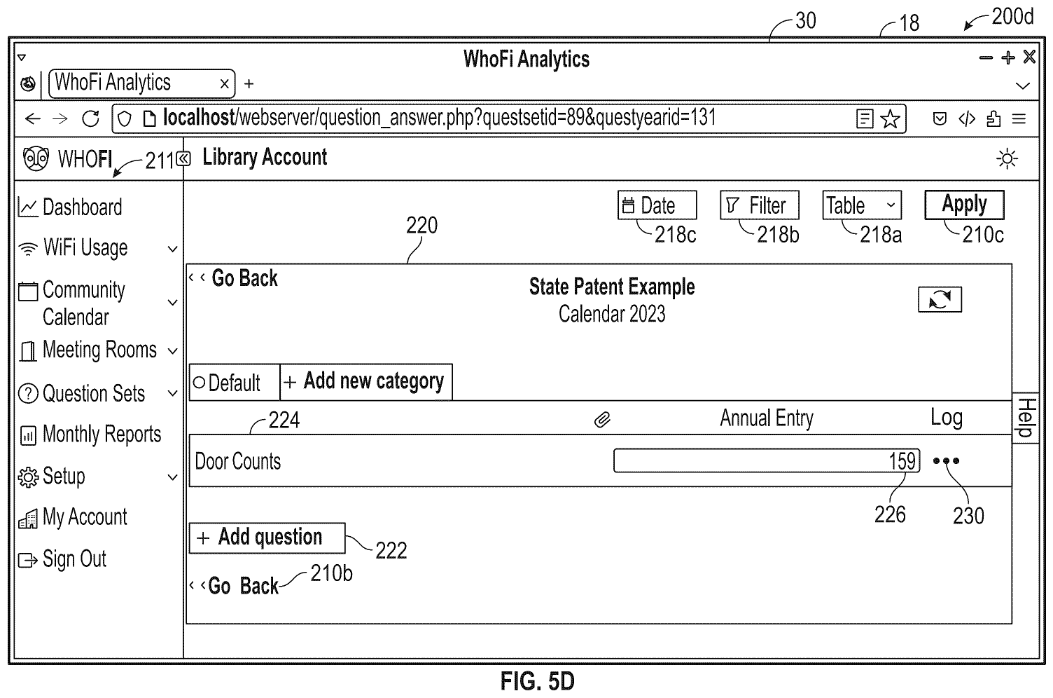

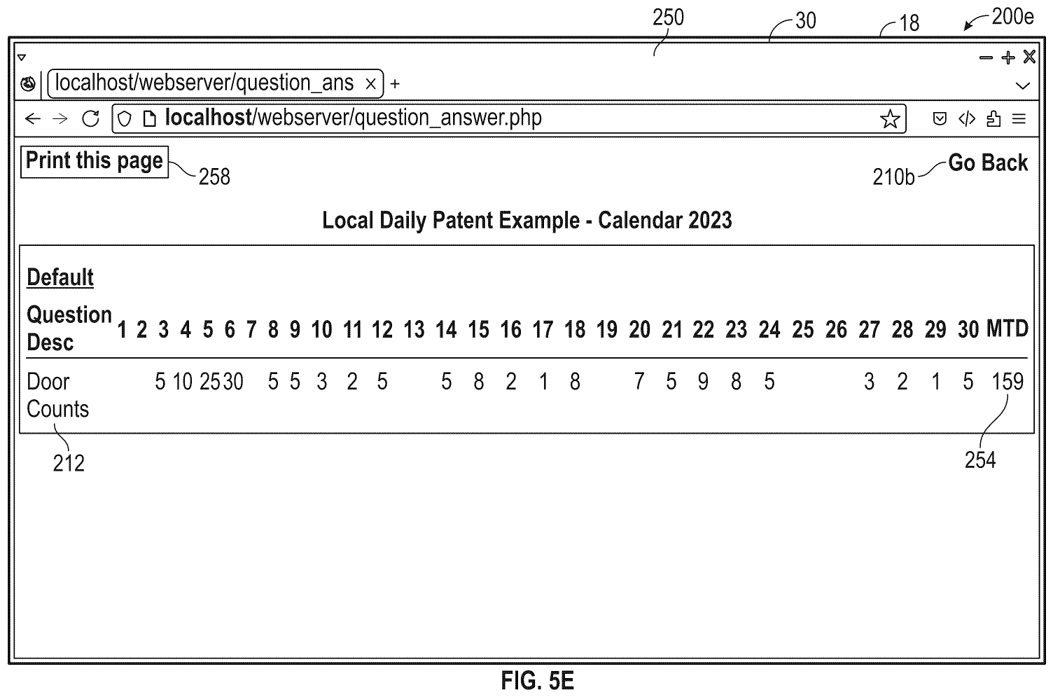

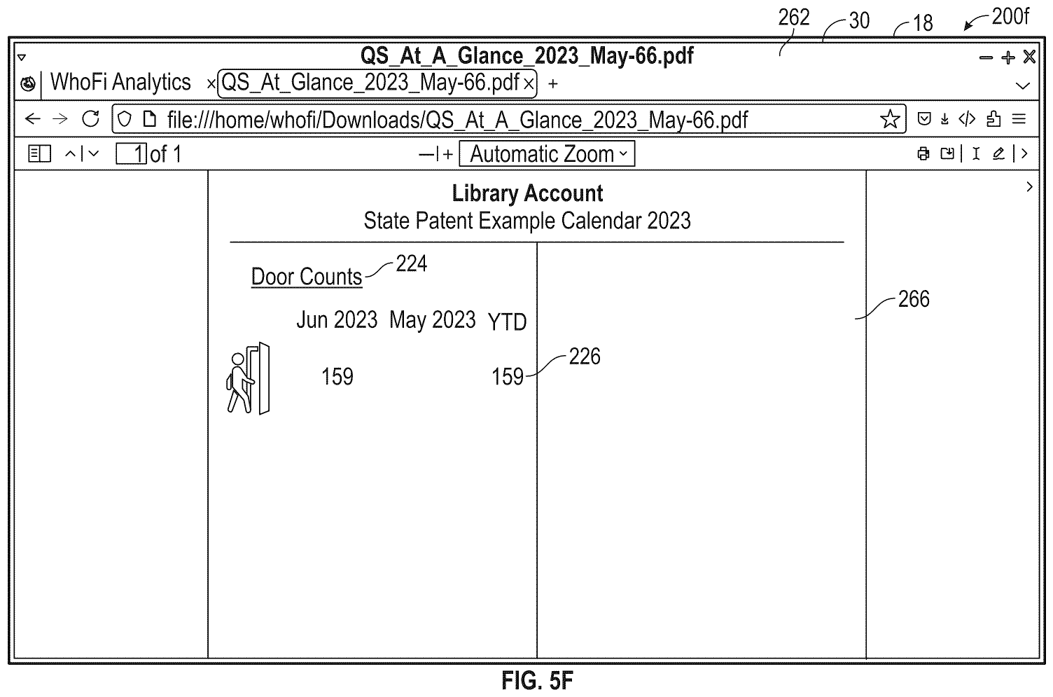

In one embodiment, receiving a report data structure having plurality of parent questions (step 154) includes receiving the plurality of parent questions from the user 14 accessing the user device 18. For example, as shown in FIG. 5A, the user 14 may access the primary user interface 30 of the user device 18 and provide the report data structure having the plurality of parent questions to the primary user interface 30 via the input device 50. The processor 58 of the user device 18 may receive the plurality of parent questions entered into the primary user interface 30 and may store the plurality of parent questions in the memory 66 and/or may transmit the plurality of parent questions to the coordination system 22, i.e., to the processor 86 of the coordination system 22. The processor 86 of the coordination system 22 may then store the plurality of parent questions in the memory 82, such as in the database 94. In one embodiment, each parent question of the plurality of parent questions may be stored with one or more question property, such as a question identifier, a question name, a question set identifier, a question category, a question type, a question numbering, a question tooltip, a question shortcode, a question transformer function, and/or a question parent. The one or more question property may also include a timeseries property such as a timeframe indicative of a timeframe to which the particular parent question is directed. The timeseries property may include, for example, at least one of: a timeframe, a date range, a start date, an end date, and a timestamp.

In one embodiment, the report data structure may be provided in a predetermined data format, such as an object-oriented data format. Non-limiting predetermined data formats may include, for example, an XML format, a YAML format, a JSON format, and/or the like.

For example, taking a library system (e.g., a public library as defined by a governing body, such as a City, State, or National government) into consideration where the library system has a first branch and a second branch. In one embodiment, the plurality of parent questions of the report data structure is a plurality of state level questions directed to a state report type. In one embodiment, the plurality of state level questions may be a combination of questions defined by the Federal Institute of Museum and Libraries and questions defined by state legislative bodies. In one embodiment, the plurality of state level questions corresponds to a particular question set, such as a state report question set and are expected to be answered by a Library system.

In one embodiment, the plurality of state level questions corresponding to the state report question set are apt to differ and/or change each year, e.g., each of the state level questions has a question timeframe indicative of a yearly timeframe having a cycle date/due date corresponding to a due date of the state level report having the report data structure of the state level report.

In one embodiment, the plurality of state level questions is entered by the library system user and/or a library system administrator. In one embodiment, the plurality of state level questions is defined by a State Data Coordinator and provided to a library system user and/or the library system administrator. In other embodiments, the State Data Coordinator may provide the report data structure having the plurality of state level questions (i.e., the plurality of parent questions).

In one embodiment, each parent question of the plurality of parent questions may have a question type, such as a multiple-choice question type, a numerical question type (e.g., an integer, decimal, or a float value), a text question type, a free response question type, a file-upload question type, a Likert scale question type, and/or the like. Each of the parent questions may be directed to a particular metric. For example, a library system may have a parent question directed to a “Door Count” metric, where an exemplary parent question may be “What was the Annual Door Count for the Library System?”, which has a question timeframe (i.e., a timeseries property) of one year (e.g., as shown below in FIG. 5A) and may be applicable to the library system as a whole, i.e., the first branch and the second branch are not treated separately, but in combination. Additional library system metrics may include, for example, desk check ins, books checked out, books delivered, programs run at the library, program attendance, library open hours, STEM programs run, STEM program attendance, and the like.

In one embodiment, receiving a plurality of child questions associated with at least one of the plurality of parent questions (step 158) includes receiving, from the user 14, the plurality of child questions from the user 14 accessing the user device 18. For example, as shown in FIG. 5B, the user 14 may access the primary user interface 30 of the user device 18 and provide each of the plurality of child questions and associate each particular child question to at least one of the plurality of parent questions via the primary user interface 30 via the input device 50. The processor 58 of the user device 18 may receive the plurality of child questions entered into the primary user interface 30 and may store the plurality of child questions in the memory 66 and/or may transmit the plurality of child questions to the coordination system 22, i.e., to the processor 86 of the coordination system 22. The processor 86 of the coordination system 22 may then store the plurality of child questions in the memory 82, such as in the database 94. In one embodiment, each child question of the plurality of child questions may be stored with one or more question property, such as a question identifier, a question name, a question set identifier, a question category, a question type, a question numbering, a question tooltip, a question shortcode, a question transformer, and/or a question parent. The one or more question property may also include a question timeframe indicative of a timeframe to which the particular child question is associated.

In one embodiment, the plurality of child questions are selected to provide a response to at least one of the plurality of parent questions; however, a particular child question may have a question timeframe selected to be a discrete interval of the question timeframe (e.g., timeseries property) of the at least one parent question. For example, the particular child question may be “What is the day's door count?”, with the question timeframe of one day. The particular child question may further be associated with a particular aspect or subgroup. Returning to the library system example above, the particular child question “What is the day's door count?” may be associated with each of the first branch and the second branch of the library system. In other words, both the first branch and the second branch may be required to provide a response to the question “What is the day's door count?” on each day (e.g., question timeframe), or for each day that particular branch is opened. Alternatively, the question timeframe may be weekly, monthly, quarterly, yearly, and/or the like, for example.

In one embodiment, associating at least one transformation correlating the plurality of child questions into responses to at least one of the plurality of parent questions (step 162) includes receiving at least one transformation from the user 14 accessing the user device 18. For example, the user 14 may access the primary user interface 30 of the user device 18 and provide at least one transformation and correlate at least one child question and at least one parent question with the transformation via the primary user interface 30 via the input device 50. The processor 58 of the user device 18 may receive the at least one transformation and the correlation between the at least one child question and at least one parent question entered into the primary user interface 30 and may store the at least one transformation and the correlation between the at least one child question and at least one parent question in the memory 66 and/or may transmit the at least one transformation and the correlation between the at least one child question and at least one parent question to the coordination system 22, i.e., to the processor 86 of the coordination system 22. The processor 86 of the coordination system 22 may then store the at least one transformation and the correlation between the at least one child question and at least one parent question in the memory 82, such as in the database 94.

In one embodiment, receiving a plurality of child questions associated with at least one of the plurality of parent questions (step 158) further includes receiving one or more input from the user 14 selecting a predefined transformation function and at least one parent question of the plurality of parent questions. For example, the user 14 may select the predefined transformation function when entering in a particular child question into the primary user interface 30 via the input device 50. The processor 58 of the user device 18 may retrieve the selected predefined transformation function and transmit the same to the coordination system 22, e.g., via the network 26. The processor 86 of the coordination system 22 may then store the selected predefined transformation function with the at least one child question in the memory 82, such as in the database 94.

In one embodiment, the processor 86 stores the selected predefined transformation function in the database 94 with a transformation function identifier and stores the transformation function identifier with the at least one child question when the at least one child question is stored in the database 94 to associate the at least one child question with the predefined transformation function.

Returning to the library system example above, the particular child question “What is the day's door count?”, being associated with each of the first branch and the second branch of the library system, may further be associated with a particular transformation function. For example, the particular child question “What is the day's door count?” may be associated with the particular transformation function where the particular transformation function provides a function linking each child question to the particular parent question. That is, when the processor 86 applies the particular transformation function to responses to the child questions stored in the database 94, the processor 86 generates an output to the transformation function as a response to the particular parent question.

As shown in FIG. 5B, the particular transformation function may be a “SUM” (summation) function. In this embodiment, the responses to the particular child question (“What is the day's door count?”) provided by each subgroup (e.g., the first branch and the second branch) for the question timeframe (e.g., for each day) are summed together into an output (e.g., the door count for each branch location for the past year). Other transformation functions may be provided as well, such as an “AVG” (average) function (e.g., determining an average of the responses to the particular child question across the question timeframe and providing the average as the output), a “MIN” (minimum) function (e.g., determining a minimum of the responses to the particular child question across the question timeframe and providing the minimum as the output), a “MAX” (maximum) function (e.g., determining a maximum of the responses to the particular child question across the question timeframe and providing the maximum as the output), and a “SD” (standard deviation) function (e.g., determining a standard deviation of the responses to the particular child question across the question timeframe and providing the standard deviation as the output).

In one embodiment, receiving one or more response to the plurality of child questions (step 166) includes receiving, from the user 14, one or more response for each question timeframe of each child question. For example, the user 14 may be prompted via the primary user interface 30 of the user device 18 with at least one of the plurality of child questions. The user 14 may provide a response to the at least one child question via the input device 50. The processor 58 of the user device 18 may receive the response from the input device 50 and may store the response in the memory 55 and/or may transmit the response to the coordination system 22 (e.g., to the processor 86 via the network 26). The processor 86 of the coordination system 22 may then store the response to the at least one child question in the memory 82, such as in the database 94. The response may be stored with the question identifier for the at least one child question to provide an association within the database 94 between the at least one child question and the response, and may be stored with a user ID of the user 14 that provided the response to the at least one child question as well as one or more response property, such as a response timestamp, a response location (e.g., the location of the user providing the response or to which the child question is directed), a response update timestamp (if the response is updated at a future time/date), and/or other response metadata. In one embodiment, the one or more response property may include a branch location or a branch ID, for example, when the user 14 is a user associated with a particular branch of a library system.

Returning again to the library system example above, the particular child question “What is the day's door count?” being associated with each of the first branch and the second branch of the library system and associated with the particular transformation function, may be provided to the primary user interface 30 of the user device 18 of a user 14 for each of the first branch and the second branch. For example, the particular child question “What is the day's door count?” may be provided to the user device 18 of a first user associated with the first branch and may be provided to the user device 18 of a second user associated with the second branch. A response to the child question received from each of the first user and the second user via the primary user interface 30 may be stored in the database 94 by the processor 86. The responses may further be stored with a question identifier of the child question as well as a user ID for the respective user providing the response, as described above.

Generating the report based on the output of the at least one transformation function and having the report data structure (step 170) may include generating, by the processor 86, an output for each transformation function associated with each parent question of the plurality of parent questions of the report data structure and may further include storing each of the outputs in the database 94 of the memory 82.

Generating the report based on the output of the at least one transformation function and having the report data structure (step 170) may include the processor 86 of the coordination system 22 generating the report having the report data structure with responses to at least one parent question of the plurality of parent questions based on the output from the at least one transformation function.

In one embodiment, generating the report (step 170) may be triggered by the user 14 providing an input to the primary user interface 30, e.g., through interaction with the input device 50 of the user device 18. In other embodiments, generating the report (step 170) may be triggered by the processor 86 based on one or more report property, such as a reporting time or reporting timeframe. For example, the report may have a reporting time based on the end of the fiscal year. In this example, the processor 86 may automatically generate the report when the current date matches, or is within a date range of, the end of the fiscal year. In another embodiment, generating the report (step 170) may be triggered when requirements of the parent question are met. For example, the report may have a requirement that the report is generated when a particular metric as measured by a particular parent question meets or exceeds a threshold. In this embodiment, the processor 86 may determine the output of the transformation function each time the user 14 enters a response to an associated child question, and, if the output meets or exceeds the threshold, the processor 86 may generate the report.

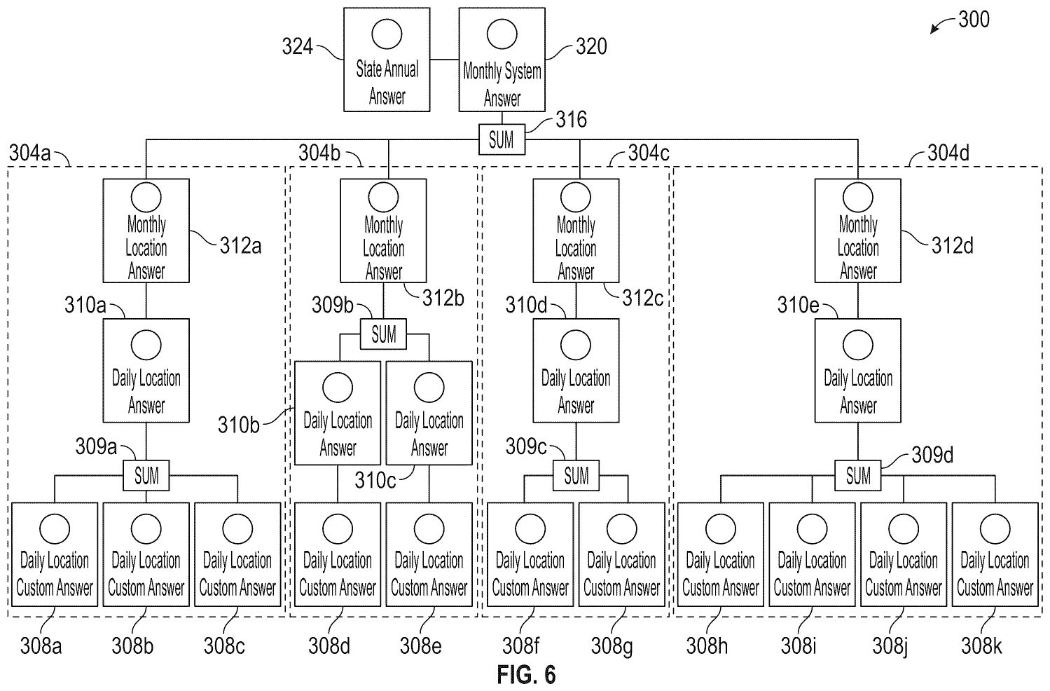

In one embodiment, generating the report (step 170) may further include recursively applying one or more transformation function to each child question associated with the plurality of parent questions of the report data structure. For example, because a child question may both by associated with a parent question and have one or more child question (grandchild question), generating the report (step 170) may comprise applying the one or more transformation function to each grandchild function (as described above in relation to child questions) to generate first outputs. The first outputs may then be provided as a response to respective child questions (e.g., to the child questions having the grandchild questions) and, along with responses provided by the user 14 and stored in the database 94, may be provided to one or more transformation functions to generate at least one second output as a response to the associated parent question and may be stored in the database 94. This step 170 may be repeated for each question in a hierarchy tree (e.g., as shown in FIG. 6) of child questions descendent from each parent question of the plurality of parent questions of the report data structure. In this way, the number of child questions in the hierarchy tree may be limited by the number of child questions in the hierarchy tree for each parent question of the plurality of parent questions described by the report data structure.

In one embodiment, generating the report (step 170) may further include generating the report to have one or more predetermined format. For example, generating the report may include generating, by the processor 86, the report in a PDF format, a CSV format, a TXT format, an HTML format, and/or the like (e.g., as shown in FIG. 5E and FIG. 5F).

Referring now to FIG. 5A, shown therein is a screenshot 200a of an exemplary embodiment of the user device 18 displaying the primary user interface 30 with an edit question screen 202 constructed in accordance with the present disclosure. As shown by the screenshot 200a, the processor 58 may display the primary user interface 30 of the coordination application 90 on the user device 18 to receive one or more input indicative of a parent question from the user 14. As shown the one or more input may be entered into one or more input field 204a-n (collectively “input fields 204”) where each input field 204 may be associated with an (optional) input label 208a-n, respectively (collectively “input labels 208”). One or more of the input fields 204 may correspond to the one or more question property of the parent question.

For example, as shown in FIG. 5A, the input fields 204 may include a question name field 204a having a question name label 208a, a question set field 204b having a question set label 208b, a question category field 204c having a question category label 208c, a question type field 204d having a question type label 208d, a question numbering field 204e having a question numbering label 208e, a question tooltip field 204f having a question tooltip label 208f, a question shortcode field 204g having a question shortcode label 208g, and a question parent field 204h having a question parent label 208h. In other embodiments, additional input fields 204 may be included and may have corresponding input labels 208. In one embodiment, the primary user interface 30 may further be provided with a navigation menu 211 to provide for navigation of the coordination application 90. The question parent field 204h may indicate whether the question provided is a parent question or a child question. For example, if the question parent field 204h is selected to indicate that there is not parent question, then the question being entered is a parent question; otherwise, the question being entered is considered a child question.

Each of the input fields 204 may receive a particular type of input from the user 14. For example, as shown in FIG. 5A, the question name field 204a may be a text entry field, the question set field 204b may be a text entry field, the question category field 204c may be a dropdown list field, the question type field 204d may be a dropdown field corresponding to the question type as described above, the question numbering field 204e may be a text field to order and/or organize an arrangement of parent questions, the question tooltip field 204f may be a text entry field, the question shortcode field 204g may be a dropdown field, and the question transformation field 204i may be a dropdown field. It should be understood that one or more of the input fields 204 may be implemented with a different field type, for example, the question numbering field 204e may be a dropdown field. Additionally, one or more of the input fields 204 may be prefilled with information, such as, for example, the question shortcode field 204g may be prefilled with a predefined shortcode.

In one embodiment, the primary user interface 30 may further include one or more input button such as a first button 210a, operable to, upon selection by the user 14, progress or submit each of the input fields 204 to the memory 66 as parent question properties, or to transmit the input fields 204 to the processor 86, and a second button 210b, operable to, upon selection by the user 14, cancel any changes to the parent question properties or to cancel submission of the input fields 204.

Referring now to FIG. 5B, shown therein is a screenshot 200b of an exemplary embodiment of the user device 18 displaying the edit question screen 202 of the primary user interface 30 constructed in accordance with the present disclosure. As shown by the screenshot 200b, the processor 58 may display the primary user interface 30 of the coordination application 90 on the user device 18 to receive one or more input indicative of a question from the user 14. As shown the one or more input may be entered into one or more input field 204a-n (collectively “input fields 204”) where each input field 204 may be associated with an (optional) input label 208a-n, respectively (collectively “input labels 208”). One or more of the input fields 204 may correspond to the one or more question property of the question. As shown in the screenshot 200b, the question parent field 204h indicates a parent question of the currently entered question; therefore, the currently entered question may be provided with additional input field 204 of a question transformation field 204i having a question transformation label 208i. The question transformation field 204i may be a dropdown list having one or more predetermined transformation function listed. The one or more transformation function may be constructed as described above in more detail.

Referring now to FIG. 5C, shown therein is a screenshot 200c of an exemplary embodiment of the user device 18 displaying a child question response screen 216 of the primary user interface 30 constructed in accordance with the present disclosure. As shown by the screenshot 200c, the processor 58 may display the primary user interface 30 of the coordination application 90 on the user device 18 to receive one or more input indicative of a response to a child question (provided as shown in FIG. 5B).

As shown in FIG. 5C, the primary user interface 30 may provide a child question 212 with one or more question response field 214. The user 14, accessing the primary user interface 30, may input a response into one or more question response field 214, which may then be sent by the processor 58 to the processor 86 executing the coordination application 90. The response may have an input format corresponding to the question type field 204d as defined when the child question 212 was submitted to the coordination application 90. As shown, only one child question 212 is displayed; however, more than one child question may be displayed at a time. For example, each child question applicable to a particular location (e.g., library branch) may be displayed at the same time. Alternatively, the one or more child question 212 displayed may be selected based on authorization of the user 14 to submit a response to the particular child question. For example, a first user may have permission to submit a response to a first child question and a second child question whereas a second user may have permission to submit a response to the first child question but not to the second child question. In this case, the first user may be provided with a list including both the first child question and the second child question, whereas the second user may be provided with a list including the first child question but not including the second child question.

In one embodiment, the processor 58 may transmit the response provided in the one or more question response field 214 to the processor 86 upon selection, by the user 14 accessing the input device 50, of a third button 210c.

In one embodiment, the primary user interface 30 further provides one or more question action input 218 such as a display format action 218a, a filter action 218b, and a date action 218c. For example, upon selection of the display format action 218a, the processor 58 may change the question display from a table format (as shown in the screenshot 200c) to an individual day format (e.g., displaying the question and one question response field 214 for each day, or question timeframe). The filter action 218b may provide one or more menu field operable to receive a selection from the user 14 indicative of a filter to apply to a list of questions displayed. The date action 218c may provide one or more date field operable to receive a selection from the user 14 indicative of a timeframe to allow for responses to the one or more question response field 214. As shown, the question response fields 214 are directed to receive a response for each day of June 2023.

In one embodiment, the child question response screen 216 may further, optionally, provide a new question button 222 operable to, upon selection by the user 14, cause the processor to display the edit question screen 202 of the primary user interface 30 of the coordination application 90 on the user device 18.

Referring now to FIG. 5D, shown therein is a screenshot 200d of an exemplary embodiment of the user device 18 displaying a parent question response screen 220 of the primary user interface 30 constructed in accordance with the present disclosure. As shown by the screenshot 200d, the processor 58 may display the primary user interface 30 of the coordination application 90 on the user device 18 to display one or more parent question 224 having a parent response 226 based on the transformation function (identified in question transformation field 204i of FIG. 5B) as applied to responses (as provided in question response fields 214 of FIG. 5C). The parent response 226 may be populated by the processor 56 based on application of the transformation function as applied to each child question of the parent question. In one embodiment, the parent response 226 is not editable by the user 14. Instead of editing the parent response 226, the user 14 may be directed to update the one or more response to the one or more child question 212 in the child question response screen 216. Upon updating the one or more response to the one or more child question 212 in the child question response screen 216, the processor 86 may recalculate or redetermine the parent response 226 and update the parent response 226 in the parent question response screen 220 automatically (or upon selection by the user). In other embodiments, an administrator may be provided an ability to update or edit the parent response 226 of the parent question 224.

In one embodiment, the parent question response screen 220 may further, optionally, provide the new question button 222 operable to, upon selection by the user 14, cause the processor 58 to display the edit question screen 202 (FIGS. 5A-B) of the primary user interface 30 of the coordination application 90 on the user device 18.

In one embodiment, a log action 230 may be provided that, upon selection by the user 14, may cause the processor 86 to transmit a list of all user changes made to any response to the child questions 212 of the parent question 224 and/or made to the parent question 224.

Referring now to FIG. 5E, shown therein is a screenshot 200e of an exemplary embodiment of the user device 18 displaying a child question report screen 250 of the primary user interface 30 constructed in accordance with the present disclosure. As shown by the screenshot 200e, the processor 58 may display the child question report screen 250 of the primary user interface 30 of the coordination application 90 on the user device 18. The child question report screen 250 may include a daily report of responses to each child question 212. The responses may be limited to a particular month or year. In one embodiment, the chronicity of the report is determined based on the question timeframe, for example.

In one embodiment, the child question report screen 250 may further include an intermediate response 254 indicative of an output of the transformation function (e.g., as selected in the question transformation field 204i in FIG. 5B) but applied to an intermediate timeframe from both the question timeframe of the child question and the question timeframe of the parent question. As shown, the intermediate response 254 is a month-to-date response based on the one or more response to the child question 212 for a particular month (e.g., June 2023).

In one embodiment, the intermediate response may be a response to an intermediate question (e.g., a child question in relation to a parent question while also a parent question in relation to a child question).

In one embodiment, the child question report screen 250 may further include a generate report button 258, that, upon selection by the user 14, may cause the processor 86 to generate the report into a PDF format, a CSV format, a TXT format, an HTML format, and/or the like (e.g., as shown in FIG. 5F).

Referring now to FIG. 5F, shown therein is a screenshot 200f of an exemplary embodiment of the user device 18 displaying a parent question report screen 262 of a report 266 in the primary user interface 30 constructed in accordance with the present disclosure. As shown by the screenshot 200f, the processor 58 may display the parent question report screen 262 in the primary user interface 30 of the coordination application 90 on the user device 18. The parent question report screen 262 may include the parent response 226 to the parent question 224. The parent responses 226 may be limited to a particular year. In one embodiment, the chronicity of the report is determined based on the question timeframe of the parent question, for example. In one embodiment, the parent question report screen 262 may include a monthly report of intermediate responses to each child question 212 as well as the parent response 226 to the parent question 224.

In one embodiment, the parent question report screen 262 may further include a generate report button 258 (as shown in FIG. 5E), that, upon selection by the user 14, may cause the processor 86 to generate the report 266 into a PDF format, a CSV format, a TXT format, an HTML format, and/or the like (e.g., as shown in FIG. 5F).

Referring now to FIG. 6, shown therein is a diagram of an exemplary embodiment of a hierarchy tree 300 constructed in accordance with the present disclosure. As shown, multiple locations 304 (e.g., a first location 304a, a second location 304b, a third location 304c, and a fourth location 304d) may respond to one or more child question 308 to generate an intermediate response 312 for the particular location 304. The intermediate responses 312 for each location are transformed by the processor 86 applying the transformation function 316 into a parent intermediate response 320 and then into a parent response 324. In one embodiment, at least one child question 308 for each location 304 is the same child question 308. In other embodiments, the child questions 308 for each location 304 are unique.

In one embodiment, the first location 304a may generate a first intermediate response 312a having an intermediate response timeframe (e.g., a monthly response timeframe) based on a first child response 308a, a second child response 308b, and a third child response 308c for the question timeframe, each having a child response timeframe (e.g., for each day of the month). In one embodiment, the first child response 308a, the second child response 308b and the third child response 308c may be transformed, by the processor 86 applying a transformation function 309a, into a first parent response 310a having a parent response timeframe (in this case corresponding to the child response timeframe as both the child responses 308a-c and the first parent response 310a have a “daily” response timeframe). The first parent response 310a may then be provided to calculate the first intermediate response 312a (e.g., having a response timeframe corresponding to a different question timeframe). In this way, the intermediate response timeframe is multiples of the intermediate and/or child response timeframes, that is, in this example, the intermediate response timeframe may be “30” indicative of the number of days in a month, while the intermediate and/or child response timeframes are “1” indicative of a particular day.

In one embodiment, the second location 304b may generate a second intermediate response 312b (e.g., a monthly response) based on a fourth child response 308d and a fifth child response 308e for the question timeframe (e.g., for each day of the month). In one embodiment, the fourth child response 308d may be provided as a second parent response 310b and the fifth child response 308e may be provided as a third parent response 310c. The second parent response 310b and the third parent response 310c may be transformed, by the processor 86 applying a second transformation function 309b, into the second intermediate response 312b.

In one embodiment, the third location 304c may generate a third intermediate response 312c (e.g., a monthly response) based on a sixth child response 308f and a seventh child response 308g for the question timeframe (e.g., for each day of the month). In one embodiment, the sixth child response 308f and the seventh child response 308g may be transformed, by the processor 86 applying a third transformation function 309c, into a fourth parent response 310d. The fourth parent response 310d may then be provided to calculate the third intermediate response 312c.

In one embodiment, the fourth location 304d may generate a fourth intermediate response 312d (e.g., a monthly response) based on an eighth child response 308h, a ninth child response 308i, a tenth child response 308j, and an eleventh child response 308k for the question timeframe (e.g., for each day of the month). In one embodiment, the eighth child response 308h, the ninth child response 308i, the tenth child response 308j, and the eleventh child response 308k may be transformed, by the processor 86 applying a fourth transformation function 309d, into a fifth parent response 310e. The fifth parent response 310e may then be provided to calculate the fourth intermediate response 312d.

In one embodiment, at the third location 304c, the sixth child response 308f may be provided in response to a child question of “What is the day's door count?” and the seventh child response 308g may be provided in response to a child question of “What is the day's computer usage count?” for the question timeframe (e.g., for each day of the month). In one embodiment, the sixth child response 308f and the seventh child response 308g may be transformed, by the processor 86 applying a third transformation function 309c, into a fourth parent response 310d where the fourth parent response 310d is in response to a parent question “What is the day's door count and computer usage count?”. The fourth parent response 310d may then be provided to calculate the third intermediate response 312c where the third intermediate response 312c may be “What is the month's door count and computer usage count?”.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
a processor; and
a memory comprising a non-transitory processor-readable medium storing processor-executable instructions that when executed by the processor, causes the processor to:
receive a plurality of parent questions having one or more question property including a timeseries property, the plurality of parent questions further having a first response based on the timeseries property;
receive a plurality of child questions directed to at least one aspect of the timeseries property and having at least one associated transformation function;
determine the first response to the plurality of parent questions based on a second response to the plurality of child questions having at least one aspect of the timeseries property and the at least one associated transformation function; and
generate a first report based on the first response and a second report based on the second response.

2. The system of claim 1, wherein the first response has a first response timeframe and the second response has a second response timeframe, the first response timeframe being a multiple of the second response timeframe.

3. The system of claim 2, wherein the plurality of child questions are associated with a plurality of subgroups, and wherein the second response comprises responses from each of the plurality of subgroups.

4. The system of claim 3, wherein the at least one associated transformation function is an operation performed on the second responses from each of the plurality of subgroups.

5. The system of claim 1, wherein the at least one associated transformation function is one of a summation function, an average function, a minimum function, a maximum function, and a standard deviation function.

6. The system of claim 1, wherein the memory further stores instructions that cause the processor to receive the plurality of parent questions from a first user and to receive the plurality of child questions from a second user.

7. The system of claim 1, wherein the plurality of parent questions are associated with a first question type and the plurality of child questions are associated with a second question type.

8. The system of claim 7, wherein the first question type and the second question type are selected from a multiple-choice question type, a numerical question type, a text question type, a free response question type, a file-upload question type, and a Likert scale question type.

9. The system of claim 1, wherein the memory further stores instructions that cause the processor to generate the first report and the second report in a format selected from a PDF format, a CSV format, a TXT format, and an HTML format.

10. The system of claim 1, wherein the timeseries property includes at least one of: a timeframe, a date range, a start date, an end date, and a timestamp.

11. A system, comprising:
a processor; and
a memory comprising a non-transitory processor-readable medium storing processor-executable instructions that when executed by the processor, causes the processor to:
receive a report data structure having plurality of parent questions;
receive a plurality of child questions directed to at least one aspect of the plurality of parent questions;
associate at least one transformation function with at least one child question of the plurality of child questions, the at least one transformation function having an output as a response to at least one parent question of the plurality of parent questions; and
generate a report based on the output of the at least one transformation function and having the report data structure.

12. The system of claim 11, wherein the plurality of parent questions has a parent question timeframe and the plurality of child questions has a child question timeframe, the parent question timeframe being a multiple of the child question timeframe.

13. The system of claim 12, wherein the memory further stores instructions what cause the processor to:
receive one or more response to the plurality of child questions, each response of the one or more response having a timestamp; and
wherein the at least one transformation function is an operation performed on each response to the plurality of child questions having a timestamp within the parent question timeframe.

14. The system of claim 11, wherein the plurality of parent questions and the plurality of child questions are associated with a plurality of question properties including at least one of a question identifier, a question name, a question set identifier, a question category, a question type, a question numbering, a question tooltip, and a question shortcode.

15. The system of claim 11, wherein the memory further stores instructions that cause the processor to store the one or more response to the plurality of child questions in a database, each response being associated with a user ID and one or more response property including at least one of a response timestamp, a response location, a response update timestamp, and a response metadata.

16. The system of claim 11, wherein the at least one transformation function is selected from a summation function, an average function, a minimum function, a maximum function, and a standard deviation function.

17. The system of claim 11, wherein generating the report is triggered based on at least one of a user input, a reporting timeframe, and a threshold associated with the plurality of parent questions being met.

18. The system of claim 11, wherein the memory further stores instructions that cause the processor to generate the report in a format selected from a PDF format, a CSV format, a TXT format, and an HTML format.

19. The system of claim 11, wherein the report data structure is provided in a predetermined data format selected from an XML format, a YAML format, and a JSON format.
